(19) United States
(12) Patent Application Publication
(10) Pub. No.: US 2018/0111400 A1
(43) Pub. Date: Apr. 26, 2018

(54) BATTERY-POWERED PRINTER, POS SYSTEM, AND METHOD FOR DRIVING BATTERY-POWERED PRINTER

(71) Applicant: TOSHIBA TEC KABUSHIKI KAISHA, Tokyo (JP)

(72) Inventor: Hiroshi TSUCHIMOTO, Numazu Shizuoka (JP)

(21) Appl. No.: 15/694,964

(22) Filed: Sep. 4, 2017

(30) Foreign Application Priority Data
Oct. 24, 2016 (JP) 2016-208022

(51) Int. Cl. B41J 29/38; H02J 7/00

(52) U.S. Cl. CPC B41J 29/38; H02P 8/12; H02J 2007/0067; H02J 7/0063

(57) ABSTRACT

A battery-powered printer includes a battery receptacle in which a battery is detachably mounted, a printing mechanism driven by electric power output from the battery during printing on a recording medium, and processor configured to identify a type of the battery mounted in the battery receptacle according to output capacity, and change a drive parameter under which the printing mechanism is driven, depending on the identified type of battery.

### CROSS-REFERENCE TO RELATED APPLICATION

This application is based upon and claims the benefit of priority from Japanese Patent Application No. 2016-208022, filed Oct. 24, 2016, the entire contents of which are incorporated herein by reference.

### FIELD

Embodiments described herein relate generally to a battery-powered printer.

### BACKGROUND

In the related art, a portable printer using a battery as a power source exists. In such a printer, it is common to set control parameters for printing according to characteristics of the battery. For example, in the related art, a technology of changing a printing speed according to a remaining battery amount has been developed.

In addition, recently, a high output battery capable of outputting a larger current is also on the market. Such a high output battery, for example, enables a printer having a thermal head to increase the number of heat generating elements that can generate heat at one time, increasing the printing speed.

However, in the printer of the related art, a printing control parameter is set in accordance with the characteristics of just one type of battery. Therefore, even if the battery is replaced by a high output battery having higher output capability, there is a possibility that the output capability of the high output battery cannot be utilized effectively.

### DESCRIPTION OF THE DRAWINGS

FIG. 1 is a perspective view of a printer according to an embodiment.

FIG. 2 is perspective view of the printer in a state where a cover is open.

FIG. 3 is a diagram schematically showing a printing mechanism of the printer according to the embodiment.

FIG. 4 is a block diagram showing a control system of the printer according to the embodiment.

FIG. 5 is a diagram schematically showing a data structure of a drive parameter table.

FIG. 6 is a flowchart depicting an example of a process performed by the printer of the embodiment.

### DETAILED DESCRIPTION

Embodiments provide a battery-powered printer and a program capable of effectively utilizing an output capacity of a battery.

In general, according to one embodiment, there is provided a printer including a battery receptacle in which a battery is detachably mounted, a printing mechanism driven by electric power output from the battery during printing on a recording medium, and a processor configured to identify a type of the battery mounted on the battery receptacle according to output capacity, and change a drive parameter under which the printing mechanism is driven, depending on the identified type of battery.

Hereinafter, an embodiment of a printer and a program will be described in detail with reference to the accompanying drawings. The embodiment which will be described below is one embodiment of the printer and the program, and does not limit a configuration, specifications, or the like thereof.

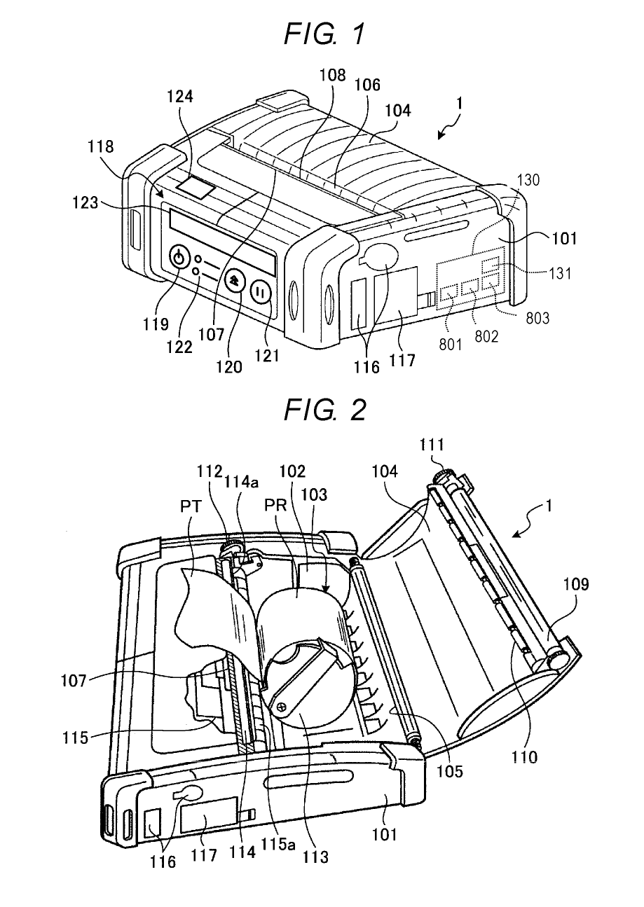

FIG. 1 is a perspective view showing an appearance of a printer 1 according to the embodiment. FIG. 2 is a perspective view showing the appearance of the printer 1 in a state where a cover 104 (described later) is open.

The printer 1 includes a rectangular parallelepiped housing 101. The housing 101 includes an internal structure for accommodating a paper roll PR on which a paper PT as a medium to be printed is wound. An opening portion 102 is formed in an upper surface of the housing 101 so as to accommodate the paper roll PR into the housing 101 therethrough. In addition, a paper accommodating unit 103 capable of detachably accommodating the paper roll PR is formed inside the housing 101. Here, for example, the paper PT is a heat sensitive paper, a label sheet in which a plurality of labels formed of a heat sensitive paper are attached to a mount of a non-heat sensitive paper, or the like.

The opening portion 102 becomes an open state or a closed state by opening and closing the cover 104 rotatably provided. The cover 104 is rotatably attached to a rear side edge 105 of the housing 101. The rear side edge 105 forms one side portion of the edge of the opening portion 102. In a state where the cover 104 is closed, a paper discharging outlet 108 for drawing out the printed paper PT is formed between an outer side 106 and a front side edge 107 of the housing 101. The outer side 106 forms a front tip portion of the cover 104. The front side edge 107 of the housing 101 forms one side of the opening portion 102.

In addition, the cover 104 includes a platen roller 109, a paper press roller 110, and a driven gear 111. The platen roller 109 is provided at a position corresponding to a line thermal head 114 in the housing 101 (see FIG. 2). That is, the platen roller 109 is in contact with a line thermal head 114 in a state where the cover 104 is closed. The paper press roller 110 is provided in the vicinity of the platen roller 109, and is in contact with the head cover 115a in the state where the cover 104 is closed. Both of the platen roller 109 and the paper press roller 110 are rotatable about rotation axes parallel to a width direction of the printer 1.

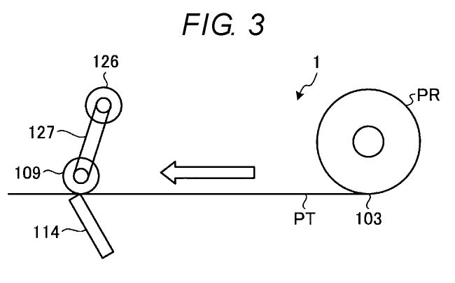

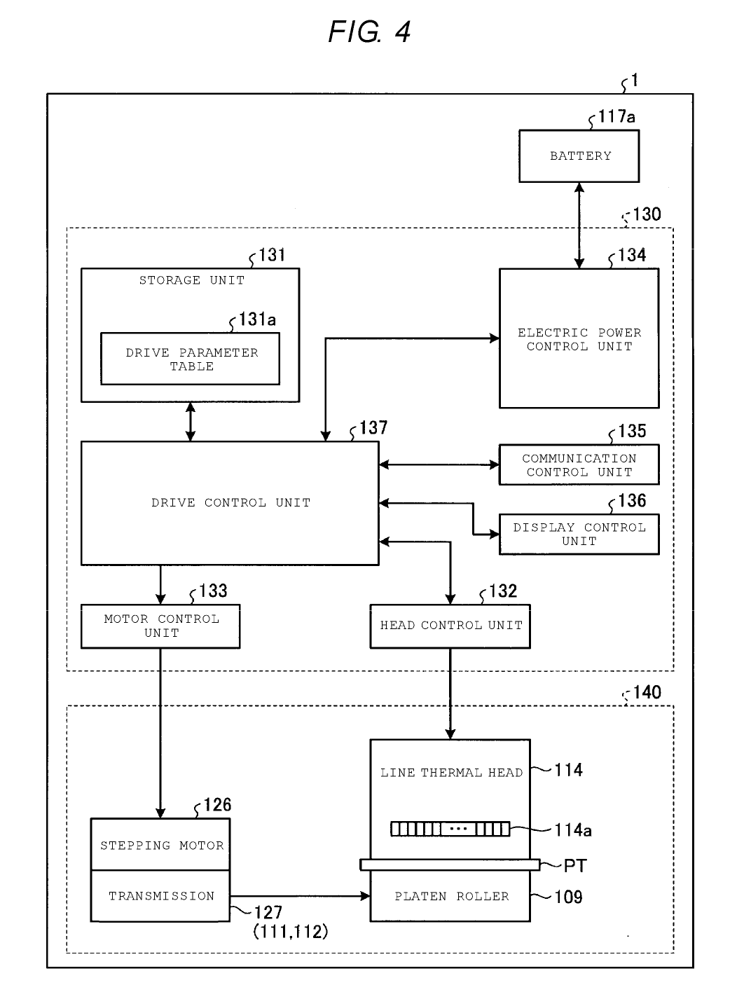

The driven gear 111 that rotates integrally with the platen roller 109 is provided on one end side of the platen roller 109. In addition, a drive gear 112 is provided at a position corresponding to the driven gear 111 inside the housing 101. The driven gear 111 meshes with the drive gear 112 in the state where the cover 104 is closed. The drive gear 112 rotates by using a stepping motor 126 (see FIG. 3 and FIG. 4) as the driving power source. Accordingly, the driven gear 111 is driven by the drive gear 112 and thereby rotationally drives the platen roller 109 connected to the driven gear 111. In the embodiment, the driven gear 111 and the drive gear 112 constitute a transmission 127 (see FIG. 3 and FIG. 4) which will be described below.

The paper roll PR is accommodated in the paper accommodating unit 103 in a state where a roll axis is parallel to the width direction of the printer 1. The paper PT of the paper roll PR is drawn out by a rotation of the platen roller 109, and transported in a direction (sub-scanning direction) of the paper discharging outlet 108. In this embodiment, the paper roll PR is accommodated detachably between a pair of guide fences 113 in the paper accommodating unit 103.

The line thermal head 114 is disposed at a position corresponding to the platen roller 109 inside the housing 101. The line thermal head 114 faces the platen roller 109 of the cover 104 in the state where the cover 104 is closed. A head bracket 115 is fixed to the housing 101, and thereby biases the line thermal head 114 upward and toward the rear side of the printer 1. The head cover 115a is mounted on the housing 101 if necessary. The head cover 115a prevents vibration by biasing the line thermal head 114.

The line thermal head 114 includes a plurality of heat generating elements 114a arranged in a line in a main scanning direction orthogonal to the sub-scanning direction. Here, the main scanning direction is parallel to the width direction of the printer 1. The heat generating elements 114a are heat generating elements that generate heat in response to energization, and each element corresponds to a pixel of one dot. The heat generating elements 114a generate heat under the control of a head control unit 132 (see FIG. 4), and thus the line thermal head 114 heats the paper PT to perform printing line by line. Since a large amount of energy is required for heating the head, the head control unit 132 drives the heat generating elements 114a in a time-divided manner during printing of one line. The maximum number of heat generating elements 114a capable of generating heat at the same time is referred to as the number of simultaneously energized dots.

In addition, a connector 116 and a battery accommodating unit 117 (e.g., a battery receptacle) are provided on one side surface of the housing 101 (see FIG. 2). The connector 116 is a connection terminal for connecting with an external device. The battery accommodating unit 117 accommodates detachably accommodating a battery 117a (see FIG. 4) as a power source for driving. The battery 117a accommodated in the battery accommodating unit 117 is connected to a power source connector (not shown) inside the housing 101.

In addition, the housing 101 includes a display and operation unit 118. The display and operation unit 118 includes a power switch 119, a paper feed button 120 for inputting a user's instruction such as paper feeding, a pause button 121 for inputting a user's instruction such as a temporary stop of the paper feeding, an indicator 122 for notifying the user of a state of the battery 117a, a liquid crystal display (LCD) 123, and a communication window 124 for infrared communication.

The printer 1 communicates various data with the external device connected through the communication window 124 and the connector 116. For example, the printer 1 receives print data which is subjected to be printed on the paper PT from the external device by this data communication, stores the print data in a storage unit 131 (see FIG. 4), and prints the print data on the paper PT. Here, for example, the external device is an information processing device such as a personal computer (PC), a POS terminal, a mobile phone, and a handy terminal.

Next, a printing mechanism of the printer 1 will be described with reference to FIG. 3. Here, FIG. 3 is a diagram schematically showing the printing mechanism of the printer 1.

As depicted in FIG. 3, in the printer 1, when the paper roll PR is accommodated in the paper accommodating unit 103, the paper PT is pulled out from the paper roll PR, and the cover 104 is closed, the pulled out paper PT is sandwiched between the platen roller 109 and the line thermal head 114 in the state where the cover 104 is closed.

In a state where the paper PT is sandwiched between the platen roller 109 and the line thermal head 114, the stepping motor 126 drives and rotates the platen roller 109 through the transmission 127 according to control of the processor 801 (a drive control unit 137) (see FIG. 4) which will be described below. With this, the paper PT is transported in the sub-scanning direction (arrow direction in FIG. 3) from the paper roll PR via the line thermal head 114 toward the paper discharging outlet 108. In addition, the line thermal head 114 performs printing on the paper PT, which is transported in the sub-scanning direction, by generating heat from the heat generating elements 114a according to control of the head control unit 132 which will be described below.

Next, a control system 130 of the printer 1 will be described. FIG. 4 is a diagram showing the control system 130 of the printer 1. As shown in FIGS. 1 and 4, the printer 1 includes the control system 130 including a processor 801, a read only memory (ROM) 802, a random access memory (RAM) 803, and a storage unit 131.

The processor 801 performs the operation of all of the functional units (the head control unit 132, a motor control unit 133, an electric power control unit 134, a communication control unit 135, a display control unit 136, and the drive control unit 137) by executing programs or the like stored in the read only memory (ROM) 802, the random access memory (RAM) 803 or the storage unit 131. The processor 801 is, for example, a central processing unit (CPU). The storage unit 131 is, for example, a flash memory. Detailed functions of the above functional units will be explained below. Moreover, all or some of the functions of the above functional units (the head control unit 132, a motor control unit 133, an electric power control unit 134, a communication control unit 135, a display control unit 136, and the drive control unit 137) can be realized by a control circuit, ASIC, programmed processor, or a combination thereof.

In addition, the printer 1 includes, as a printing mechanism 140, the platen roller 109, the line thermal head 114 (heat generating elements 114a), the stepping motor 126, and the transmission 127 (driven gear 111 and drive gear 112) described above.

The storage unit 131 is a storage medium such as a flash memory. The storage unit 131 stores various pieces of setting information such as a drive parameter table 131a (see FIG. 4) in which drive parameters of the printing mechanism are set, in addition to the program relating to control of the printer 1.

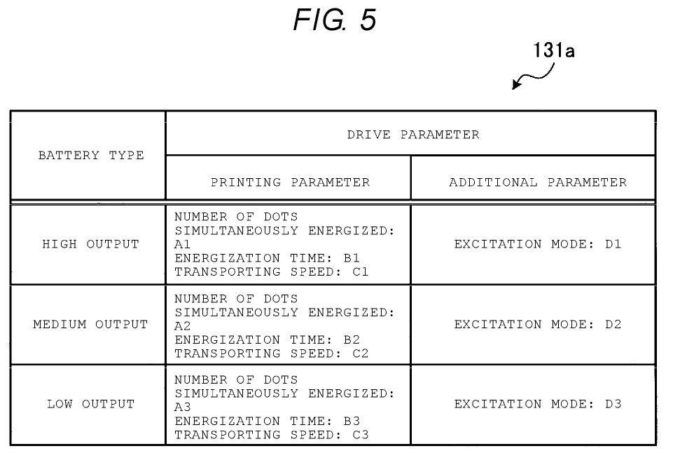

FIG. 5 is a diagram showing schematically a data structure of the drive parameter table 131a. As shown in FIG. 5, drive parameters of the printing mechanism for each type of the battery are set in the drive parameter table 131a. The battery types are types classified based on the output characteristics of the battery 117a (e.g., output capacity). For example, the battery types can be classified based on a maximum value or the like of a current which can be output by the battery 117a.

The method for classifying the battery types is not limited to specific one. Various methods may be adopted. For example, physical quantities (for example, current values) which serve as indices of classification may be divided by a range having a predetermined width, and the battery types may be classified based on the divided ranges. FIG. 5 shows an example in which the battery 117a is classified into three levels of “high output”, “medium output”, and “low output” based on the maximum value of the current which can be output from the battery 117a. The number of classifications of the battery type is not limited to three as long as the number of classifications is two or more.

The drive parameter is roughly divided into a printing parameter and an additional parameter. The printing parameter is a parameter defining various setting values of the printing mechanism 140 relating to a printing operation of the print data. Examples of the printing parameter include the number of dots which are simultaneously energized, an energization time of the heat generating elements 114a, a transport speed of the paper PT, and the like.

The additional parameter is a parameter additionally defining a setting value of an operation of the printing mechanism 140 in relation to the printing operation of the print data. Examples of the additional parameter include an excitation method (excitation mode) of the stepping motor 126 or the like.

A setting value in accordance with battery type of the battery 117a which can be accommodated in a battery accommodating unit 117 is set in each of the drive parameters. Here, it is assumed that the setting value, as the printing parameter, is set such that the printing speed of the printing mechanism 140 is faster as the battery, which is accommodated in a battery accommodating unit 117, is of a battery type that generates higher output capability, that is, of the battery type that can output a higher current value. For example, it is preferable that the number of dots which are simultaneously energized is set to a larger value as the output capability of the battery increases. In other words, it is preferable to set the number time divisions of driving the line thermal head 114 to be small. In addition, it is preferable to set the energization time to a shorter time as the output capacity of the battery increases. In addition, it is preferable to set the transport speed of the paper PT to a higher speed as the output capacity of the battery increases.

In addition, it is assumed that the setting value, as the additional parameter, is set such that the output capacity is utilized more effectively as the output capacity of the battery increases. For example, the excitation method of the stepping motor 126 may be set so as to use dual-phase excitation with high power consumption or the like in a case where the battery is of the high output type, to use 1-2 phase excitation in a case where the battery is of the medium output type, and to use single-phase excitation in a case where the battery is of the low output type.

As described above, by setting the drive parameter, the printing mechanism 140 driven based on the drive parameter can increase the printing speed by utilizing effectively the output capacity of the battery 117a.

Returning to FIG. 4, the head control unit 132 controls electric power supplied to heat generating elements 114a by energizing the line thermal head 114 so as to cause the heat generating elements 114a to generate heat in accordance with the print data under the control of the drive control unit 137. Here, the magnitude of the energy to be supplied for printing is in proportion to the number of heat generating elements 114a that are actually energized for printing.

The motor control unit 133 controls the transport speed of the paper PT, that is, the printing speed in the sub-scanning direction of the line thermal head 114 by outputting the drive pulse signal to the stepping motor 126 under the control of the drive control unit 137.

The electric power control unit 134 controls turning on and turning off of the electric power supplied from the battery 117a in the battery accommodating unit 117, according to the turning on and turning off operations of the power switch 119 of the display and operation unit 118. Specifically, the electric power control unit 134 supplies the electric power of the battery 117a to each unit of the printer 1, when the power switch 119 is turned on.

In addition, the electric power control unit 134 identifies the battery type of the battery 117a accommodated in the battery accommodating unit 117, and notifies the drive control unit 137 of the identification result. Here, the method for identifying the battery type is not limited to specific one. Various methods may be adopted. For example, the electric power control unit 134 may obtain identification information indicating the battery type from the battery 117a and identify the battery type of the battery 117a based on the identification information obtained from the battery 117a. The identification information may be information indicating the output characteristics, a brand name, or the like stored in the battery 117a. In addition, the identification information may be information obtained by performing an analogue to digital conversion of a resistance value of a resistor provided in the battery 117a for identifying the battery type.

The communication control unit 135 communicates various data with the external device connected through the connector 116, the communication window 124, or the like by using a communication interface (not shown). For example, the communication control unit 135 receives the print data transmitted from the external device, and stores the received print data in the storage unit 131. Examples of the communication interface include infrared communication such as IrDA, USB, wireless local area network (LAN), RS-232C, Bluetooth (registered trademark), and the like.

The display control unit 136 controls contents displayed on an LCD 123 of the display and operation unit 118. For example, the contents displayed may include electric wave reception state or the like.

The drive control unit 137 manages the operations of the respective units of the printer 1. The drive control unit 137 controls the head control unit 132 and the motor control unit 133 so as to cause the print data stored temporarily in the storage unit 131 to be printed on the paper PT. In addition, the drive control unit 137 deletes the print data, which has already been printed, from the storage unit 131.

In addition, the drive control unit 137 controls the operation of the printing mechanism 140 based on the drive parameter corresponding to the battery type identified in the electric power control unit 134. Specifically, the drive control unit 137 specifies the drive parameter corresponding to the battery type notified from the electric power control unit 134 from the drive parameters stored in the drive parameter table 131a. Then, the drive control unit 137 controls the operation of the printing mechanism 140 based on various setting values included in the specified drive parameter (printing parameter and additional parameter).

For example, the drive control unit 137 controls the number of the heat generating elements 114a which can be energized at the same time by the head control unit 132 and the energization time thereof based on the number of dots which are simultaneously energized and the energization time set in the printing parameter. In addition, the drive control unit 137 controls the motor control unit 133 based on the transport speed set in the printing parameter, to thereby control the transport speed of the paper PT transported by driving of the stepping motor 126. Further, the drive control unit 137 outputs the drive pulse signal for realizing the excitation mode to the motor control unit 133 based on the excitation mode set in the additional parameter.

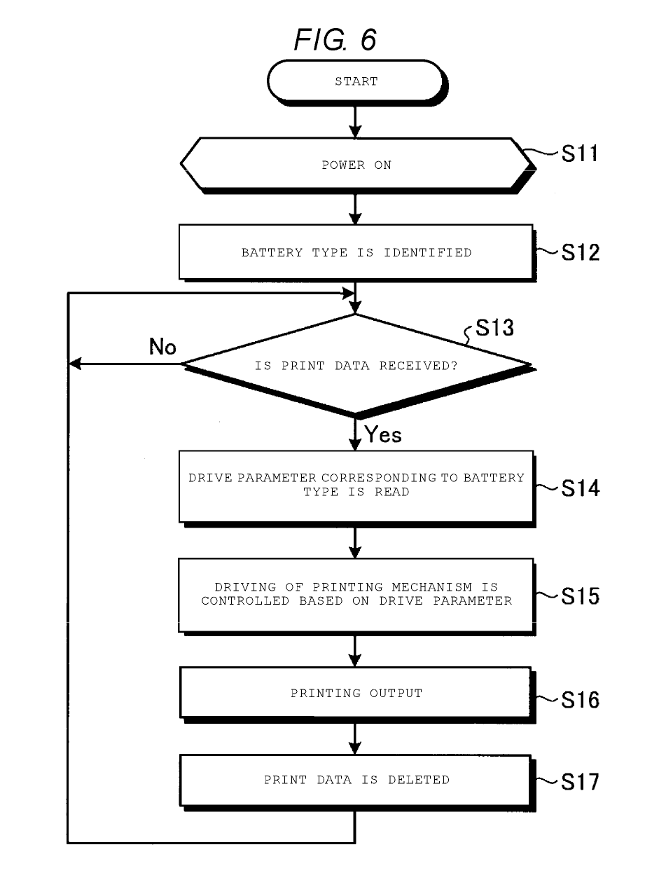

Next, a process performed by the printer 1 will be described with reference to FIG. 6. FIG. 6 is a flowchart depicting an example of the process performed by the printer 1 (control systems 130).

First, when the power source of the printer 1 is turned on by the turning on operation or the like of the power switch 119, the electric power control unit 134 supplies the electric power supplied from the battery 117a to each unit of the printer 1 (step S11). Subsequently, the electric power control unit 134 identifies the battery type of the battery 117a accommodated in the battery accommodating unit 117 (step S12).

Subsequently, the drive control unit 137 waits until the communication control unit 135 receives the print data (step S13; No), and if the communication control unit 135 receives the print data (step S13; Yes), the drive control unit 137 proceeds to execute step S14.

In step S14, the drive control unit 137 specifies the drive parameter corresponding to the battery type identified in step S12 from the drive parameter table 131a, and reads the identified drive parameter (step S14). Subsequently, the drive control unit 137 controls driving of the printing mechanism 140 (head control unit 132 and motor control unit 133) based on setting content of the read drive parameter (step S15), and causes the printing mechanism 140 to perform printing onto the paper PT based on the print data (step S16).

Accordingly, when the printing of the print data is completed, the drive control unit 137 deletes the print data from the storage unit 131 (step S17), and the process returns to step S13.

As described above, the printer 1 of the embodiment identifies the battery type of the battery 117a accommodated in the battery accommodating unit 117, and controls the driving of the printing mechanism 140 by using the drive parameter corresponding to the identified battery type. With this, even if the battery 117a is replaced, it is possible to drive the printing mechanism 140 using the drive parameter which is suitable for the battery type of the battery 117a after the replacement. Thus, it is possible to effectively utilize the output capacity of the battery 117a accommodated in the battery accommodating unit 117.

In addition, the printer 1 of the embodiment changes the drive parameter so as to increase the printing speed of the printing mechanism 140 as the battery type of the battery 117a is a type of the higher output capacity. With this, the printer 1 can utilize effectively the output capacity of the battery 117a and increase the printing speed.

So far, while certain embodiments of the present disclosure have been described, these embodiments have been presented byway of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the embodiment, the drive parameter corresponding to the battery type of the battery 117a is specified based on the drive parameter table 131a. However, the embodiment is not limited thereto. For example, the drive parameter corresponding to the battery type of the battery 117a may be specified by using a relational expression with which a corresponding driving parameter can be derived from the battery type of the battery 117a.

In addition, in the embodiment, the battery type of the battery 117a at the time of turning on the power source of the printer 1 is identified (see step S12 of FIG. 6). However, a timing for identifying the battery type is not limited thereto. For example, the electric power control unit 134 may identify the battery type at a timing at which printing of the print data is performed. In this case, the electric power control unit 134 can identify the battery type at the timing at which printing of the print data is performed by performing the process of step S12 shown in FIG. 6 between steps S13 and S14.

In addition, the exemplary embodiment is applied to the independent printer 1. However, the present disclosure is not limited thereto and may be applied to the information processing device such as a POS terminal including the control system 130 and the printing mechanism 140 of the above-described printer 1. In addition, in the embodiment, the printing mechanism 140 of the printer 1 is of the thermal type. However, the printing mechanism 140 is not limited thereto, and may be implemented as another method such as an ink jet method. In this case, it is assumed that the drive parameter for each battery type is set to a setting value based on a method of the printing mechanism 140.

In addition, the program to be executed by the printer 1 of the above-described embodiment is previously provided by being incorporated in a storage medium (ROM or storage unit) included in the printer 1, but the embodiment is not limited thereto. The program may be configured to be provided by being recorded on a computer-readable recording medium such as a CD-ROM, a flexible disk (FD), a CD-R, and a digital versatile disk (DVD) in an installable format or executable format file. Furthermore, the storage medium is not limited to a medium independent of the computer or an embedded system, but also includes a storage medium where a program transmitted through a LAN, the Internet, or the like is downloaded thereto and stored or temporarily stored therein.

In addition, the program to be executed by the printer 1 of the above-described embodiment may be configured to be provided by being stored on a computer connected to a network such as the Internet and by being downloaded via a network, or may be configured to be provided or distributed via the network such as the Internet.

What is claimed is:

1. A battery-powered printer, comprising:
a battery receptacle in which a battery is detachably mounted;
a printing mechanism driven by electric power output from the battery during printing on a recording medium; and
a processor configured to:
identify a type of the battery mounted in the battery receptacle according to output capacity; and
change a driving parameter under which the printing mechanism is driven, depending on the identified type of battery.

2. The printer according to claim 1, wherein the processor changes the driving parameter so as to set a higher printing speed for the printing mechanism, as the output capacity of the type of the battery becomes higher.

3. The printer according to claim 1, wherein
the printing mechanism includes a thermal head in which a plurality of heat generating elements for generating heat are arranged, and is configured to perform the printing on the recording medium by generating heat through the heat generating elements, and
the processor sets the number of the heat generating elements that are energized at the same time depending on the identified type of battery.

4. The printer according to claim 1, wherein
the printing mechanism includes a thermal head in which a plurality of heat generating elements for generating heat are arranged, and is configured to perform the printing on the recording medium by generating heat through the heat generating elements, and
the processor sets a time period during which the heat generating elements are energized depending on the identified type of battery.

5. The printer according to claim 1, wherein
the printing mechanism includes a transporting mechanism that transports the recording medium, and
the processor sets a transport speed of the transporting mechanism depending on the identified type of battery.

6. The printer according to claim 5, wherein
the transporting mechanism includes a stepping motor, and
the processor sets excitation modes under which the stepping motor is driven, depending on the identified type of battery.

7. The printer according to claim 1, wherein the processor changes the driving parameter under which the printing mechanism is driven depending on the identified type of battery and a drive parameter table in which drive parameters for the printing mechanism for each type of the battery are set.

8. The printer according to claim 1, wherein the processor sets the driving parameter under which the printing mechanism is driven depending on the identified type of battery and a relational expression with which a corresponding driving parameter can be derived from the type of the battery.

9. A POS system, comprising:
a POS terminal configured to generate print data; and
a battery-powered printer including a battery receptacle in which a battery is detachably mounted, a printing mechanism driven by electric power output from the battery during printing on a recording medium, and a processor configured to:
identify a type of the battery mounted in the battery receptacle according to output capacity; and
change a driving parameter under which the printing mechanism is driven, depending on the identified type of battery.

10. The system according to claim 9, wherein the processor changes the driving parameter so as to set a higher printing speed for the printing mechanism, as the output capacity of the type of the battery becomes higher.

11. The system according to claim 9, wherein
the printing mechanism includes a thermal head in which a plurality of heat generating elements for generating heat are arranged, and is configured to perform the printing on the recording medium by generating heat through the heat generating elements, and
the processor sets the number of the heat generating elements that are energized at the same time depending on the identified type of battery.

12. The system according to claim 9, wherein
the printing mechanism includes a thermal head in which a plurality of heat generating elements for generating heat are arranged, and is configured to perform the printing on the recording medium by generating heat through the heat generating elements, and
the processor sets a time period during which the heat generating elements are energized depending on the identified type of battery.

13. The system according to claim 9, wherein
the printing mechanism includes a transporting mechanism that transports the recording medium, and
the processor sets a transport speed of the transporting mechanism depending on the identified type of battery.

14. The system according to claim 13, wherein
the transporting mechanism includes a stepping motor, and
the processor sets excitation modes under which the stepping motor is driven, depending on the identified type of battery.

15. The system according to claim 9, wherein the processor changes the driving parameter under which the printing mechanism is driven, depending on the identified type of battery and a drive parameter table in which drive parameters for the printing mechanism for each type of the battery are set.

16. The system according to claim 9, wherein the processor sets the driving parameter under which the printing mechanism is driven, depending on the identified type of battery and a relational expression with which a corresponding driving parameter can be derived from the type of the battery.

17. A method for driving a battery-powered printer that includes a battery receptacle in which a battery is detachably mounted, and a printing mechanism driven by electric power output from the battery during printing on a recording medium, the method comprising:
identifying a type of the battery mounted in the battery receptacle according to output capacity; and
changing a driving parameter under which the printing mechanism is driven, depending on the identified type of battery.

18. The method according to claim 17, wherein the driving parameter is changed so as to set a higher printing speed for the printing mechanism, as the output capacity of the type of the battery becomes higher.

19. The method according to claim 17, wherein
the printing mechanism includes a thermal head in which a plurality of heat generating elements for generating heat are arranged, and is configured to perform the printing on the recording medium by generating heat through the heat generating elements, and
the number of the heat generating elements that are energized at the same time is set depending on the identified type of battery.

20. The method according to claim 17, wherein
the printing mechanism includes a thermal head in which a plurality of heat generating elements for generating heat are arranged, and is configured to perform the printing on the recording medium by generating heat through the heat generating elements, and
a time period during which the heat generating elements are energized is set depending on the identified type of battery.
